(19) United States
(12) Patent Application Publication
(10) Pub. No.: US 2008/0011285 A1
(43) Pub. Date: Jan. 17, 2008

(54) Trailer-mounted rotisserie grill

(76) Inventors: Mark Stephen Milligan, Fremont, NC (US); Harold Tew Corbett, Selma, NC (US)

Correspondence Address: David O. Simmons;Galasso & Associates LP, P.O. Box 26503, Austin, TX, 78755-0503, US

(21) Appl. No.: 11/484,969

(22) Filed: Jul. 12, 2006

(51) Int. Cl. A47J 37/00

(52) U.S. Cl. 126/25 R

(57) ABSTRACT

A trailer-mounted grill comprises a trailer, a rotisserie grill assembly and a drive system. The trailer includes a frame structure and wheels rotatably attached to the trailer structure in a manner enabling the wheels to rollably support the frame structure on a surface. The rotisserie grill assembly includes a cooking chamber attached to the frame structure and a rotisserie apparatus rotatably attached to the cooking chamber. The cooking chamber includes an interior space and the rotisserie apparatus includes spaced-apart grill units within the interior space of the cooking chamber such that the grill units are rotatable within the interior space of the cooking chamber. The drive system is engaged with the rotisserie apparatus for rotating the rotisserie apparatus with respect to the cooking chamber.

### FIELD OF THE DISCLOSURE

The disclosures made herein relate generally to outdoor grills and, more particularly, to rotisserie grills and trailer mounted grills.

### BACKGROUND

Large gatherings of people often involve cooking outdoors. To feed numerous people, large cuts of meat are often cooked. When such large cuts of meat are to be cooked, on-site cooking devices (e.g., outdoor grills located in public parks, outdoor grills often owned by consumers) are not large enough to accommodate large cuts of meat. Thus, large portable trailer-mounted grills were developed to meet this need, as they may be easily transported to the site of the gathering.

However, common trailer-mounted grills often include a stationary cooking surface and heat source, where the heat source cooks primarily one side of the meat (e.g., the bottom of the meat). In addition, the heat from the heat source is often unevenly distributed about the cooking surface. Thus, the meat must be re-oriented (e.g. flipped, turned, and/or rotated) to fully and evenly cook the meat. Often, the user must re-orient the meat at a specific time to avoid over- or under-cooking one side of the meat, which may be difficult in these inherently social situations. Re-orientation of the meat may also be impractical for large and/or delicate cuts of meat.

When cooked on common trailer-mounted grills that utilize a stationary cooking surface and heat source, the juices of the meat migrate to the top surface of the meat, and collect in a small pool. When the meat is re-oriented (e.g., flipped over), the juices dump onto the heat source. Thus, these juices leave the meat, often resulting in cooked meat that tastes dry.

Therefore, a trailer-mounted grill that overcomes drawbacks associated with conventional trailer-mounted grills would be advantageous, desirable and useful.

### SUMMARY OF THE DISCLOSURE

Embodiments of the present invention comprise a trailer-mounted rotisserie grill that automatically turns a food item over a heat source. Such a trailer mounted rotisserie grill overcomes a number of shortcomings associated with conventional trailer mounted grills. By rotating a food item (e.g., a piece of meat) over the heat source, the present invention enables heat to be more uniformly and evenly applied to the food item than is the case with a conventional stationary cooking surface. Such rotation of the food item eliminates the need to manually re-orient the food item with respect to the heat source. Furthermore, the uniform and even application of heat serves to cook the food item more evenly and with less potential for burning and/or overcooking.

In one embodiment of the present invention, a trailer-mounted grill comprises a trailer, a cooking chamber, a meat holding structure and a drive system. The trailer includes a frame structure and wheels rotatably attached to the trailer structure in a manner enabling the wheels to rollably support the frame structure on a surface. The cooking chamber is attached to the frame structure. The meat holding structure is rotatably disposed within an interior space of the cooking chamber. The drive system is coupled to the meat-holding structure for rotating the meat-holding structure with respect to the cooking chamber.

In another embodiment of the present invention, a trailer-mounted grill comprises a trailer, a rotisserie grill assembly and a drive system. The trailer includes a frame structure and wheels rotatably attached to the trailer structure in a manner enabling the wheels to rollably support the frame structure on a surface. The rotisserie grill assembly includes a cooking chamber attached to the frame structure and a rotisserie apparatus rotatably attached to the cooking chamber. The cooking chamber includes an interior space and the rotisserie apparatus includes spaced-apart grill units within the interior space of the cooking chamber such that the grill units are rotatable within the interior space of the cooking chamber. The drive system is engaged with the rotisserie apparatus for rotating the rotisserie apparatus with respect to the cooking chamber.

In another embodiment of the present invention, a trailer-mounted grill comprises a trailer, a rotisserie grill assembly, a drive system, a deep fryer cooking structure and a fuel tank. The trailer includes a frame structure and wheels rotatably attached to the trailer structure in a manner enabling the wheels to rollably support the frame structure on a surface. The rotisserie grill assembly includes a cooking chamber attached to the frame structure. The rotisserie apparatus is rotatably attached to the cooking chamber and a gas burner is mounted within the cooking chamber. The cooking chamber includes an interior space and the rotisserie apparatus includes spaced-apart grill units within the interior space of the cooking chamber such that the grill units are rotatable within the interior space of the cooking chamber. The drive system is engaged with the rotisserie apparatus for rotating the rotisserie apparatus with respect to the cooking chamber. The deep fryer cooking structure is attached to the frame structure adjacent the rotisserie grill assembly. The fuel tank is attached to the frame structure in side-by-side relationship with respect to the deep fryer cooking structure. The fuel tank is coupled to a burner of the cooking chamber and a burner of the deep fryer cooking structure for supplying fuel thereto.

Turning now to specific aspects of the present invention, in at least one embodiment, the meat-holding structure includes spaced-apart grill units and a first one of the grill units is movable with respect to a second one of the grill units for enabling a food item to be secured therebetween.

In at least one embodiment of the present invention, the second one of the grill units is adjustable with respect to the first one of the grill units.

In at least one embodiment of the present invention, the first one of the grill units is rotatably mounted on the cooking chamber and the drive system is attached to the first one of the grill units for rotating the first one of the grill units with respect to the cooking chamber.

In at least one embodiment of the present invention, the cooking chamber is drum-shaped and a rotational axis of the first one of the grill units extends along a longitudinal axis of the cooking chamber.

In at least one embodiment of the present invention, the cooking chamber includes a main body and a door pivotably attached to the main body, a pivot axis of the door extends generally parallel with the longitudinal axis of the cooking chamber and the door covers an access opening in the main body.

In at least one embodiment of the present invention, the door includes a counterweight extending therefrom away from the access opening such that the counterweight exerts a gravity-induced door opening force as the door is being moved from a closed position toward an open position.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a perspective view showing an embodiment of a trailer-mounted rotisserie grill configured in accordance with the present invention.

FIG. 2 is a rear view of the trailer-mounted rotisserie grill apparatus shown in FIG. 1.

FIG. 3 is a cross-sectional view taken along the line 3-3 in FIG. 2.

FIG. 4 is a perspective view showing a rotisserie apparatus of the trailer-mounted rotisserie grill shown in FIG. 1.

### DETAILED DESCRIPTION OF THE DRAWING FIGURES

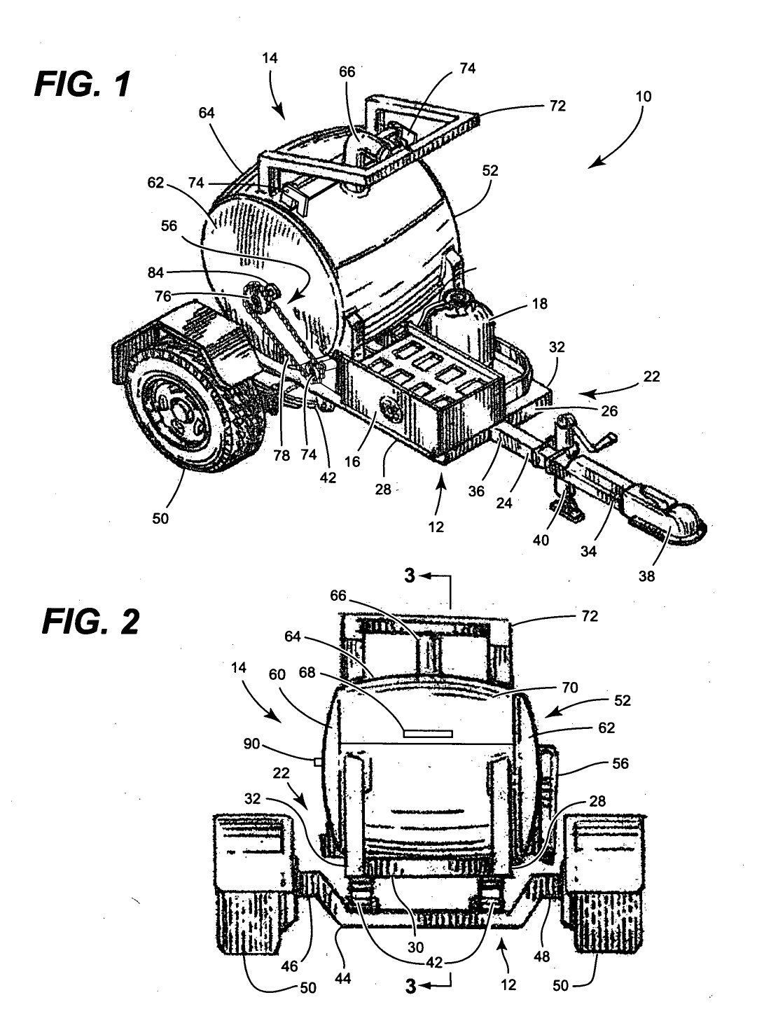

FIGS. 1-4 depict various aspects of an embodiment of a trailer-mounted rotisserie grill configured in accordance with the present invention, which is referred to herein as the trailer-mounted rotisserie grill 10. The trailer-mounted rotisserie grill 10 comprises a trailer portion 12, a rotisserie grill portion 14, a deep fryer cooking structure 16, and a fuel tank 18. The rotisserie grill portion 14 is rigidly attached to the trailer portion 12, which allows the rotisserie grill portion 14 to accommodate large cuts of meat 20, while remaining portable. The deep fryer cooking structure 16 and the fuel tank at each attached to the trailer portion and are in side-by-side relationship with respect to each other adjacent the rotisserie grill portion 14. The rotisserie grill portion 14 includes a burner 21 that receives fuel from the fuel tank 18 via a fuel supply line 23. The deep fryer cooking structure 16 includes a burner 25 that receives fuel from the fuel tank 18 via a fuel supply line 23.

The rotisserie grill portion 14 evenly cooks the meat 20 by rotating the meat 20 constantly during cooking. The rotisserie grill portion 14 provides added convenience over a stationary cooking surface, as it does not require the user to re-orient the meat 20 during cooking. The juices of the meat 20 migrate to the surface and evenly baste the meat 20 as it rotates, resulting in the cooked meat 20 being better tasting.

Referring now to FIGS. 1-3, the trailer portion 12 includes a rectangular frame structure 22 (i.e., frame 22), and an elongated hitch member 24. The rectangular frame structure 22 has a first side 26, a second side 28, a third side 30, and a forth side 32.

The elongated hitch member 24 (i.e., a trailer tongue 24) has a first end portion 34 and a second end portion 36. A hitch mount 38 is fixedly attached to the first end portion 34. The second end portion 36 of the elongated hitch member 24 is fixedly attached and substantially perpendicular to the first side 26 of the rectangular frame structure 22. A jacking device 40 (i.e., a trailer tongue jack 40) is affixed to the elongated hitch member 24 between the hitch mount 38 and the second end portion 36. The hitch mount 38 provides a means of attaching the trailer-mounted rotisserie grill 10 to a vehicle. The jacking device 40 provides a means of lifting the hitch mount 38 on and off of the vehicle and levelling the entire trailer-mounted rotisserie grill 10 once separated from the vehicle.

The rectangular frame structure 22 is suspended by springs 42 (e.g., common “leaf” springs 42). The springs 42 are attached to the second side 28 and forth side 32 of the rectangular frame structure 22. An elongated axle member 44 has a first end 46 and a second end 48. Wheels 50 are attached to the first end 46 and second end 48 of the elongated axle member 44. The springs 42 are attached to the elongated axle member 44 (i.e., axle 44) between the first end 46 and the second end 48. This arrangement orients and locates the elongated axle member 44 substantially perpendicular to the second side 28 and forth side 32 of the rectangular frame structure 22 and the elongated hitch member 24, while permitting sprung vertical movement of the axle 44 relative to the frame 22.

The axle 44 is of a shape that locates the frame 22 closer to the center of the wheels 50 in the interest of reducing the overall height of the trailer-mounted rotisserie grill 10. However, it is contemplated herein that the axle 44 may be of any shape, form, or structure. In addition, the frame 22 is of a rectangular shape, however the frame may be of any shape with any number of sides.

The springs 42 are of a “leaf” type that suspend the frame 22 and locate the axle 44. It is contemplated herein that any manner of axle suspension or location may be used (e.g., common vehicle and trailer suspension designs such as multiple links and coil springs, or torsion bars). It is further contemplated herein that individual axles may be used for each of the wheels 50 (i.e., independent suspension axles). While the trailer portion 12 includes two wheels (i.e., the wheels 50), it is contemplated herein that a different number of wheels may be used. For example, the trailer portion 12 may include a tandem axle in which four wheels would be used The rotisserie grill portion 14 is fixedly attached to the frame 22 and includes a cooking chamber 52, a rotisserie apparatus 54, a drive system 56, and a motor 58. The cooking chamber includes a first closed end 60, a second closed end 62, a door 64, and a vent 66. The rotisserie grill portion 14 is fixedly attached to the frame 22 nearest the third side 30. The door 64 is movable between an open position O and a closed position C for permitting a user to gain access to an interior space of the cooking chamber 52 via an access opening covered by the door 64. The cooking chamber 52 is preferably, but not necessarily generally cylindrical in shape. However, it is contemplated herein that the cooking chamber 52 may be of a different shape (e.g., rectangular).

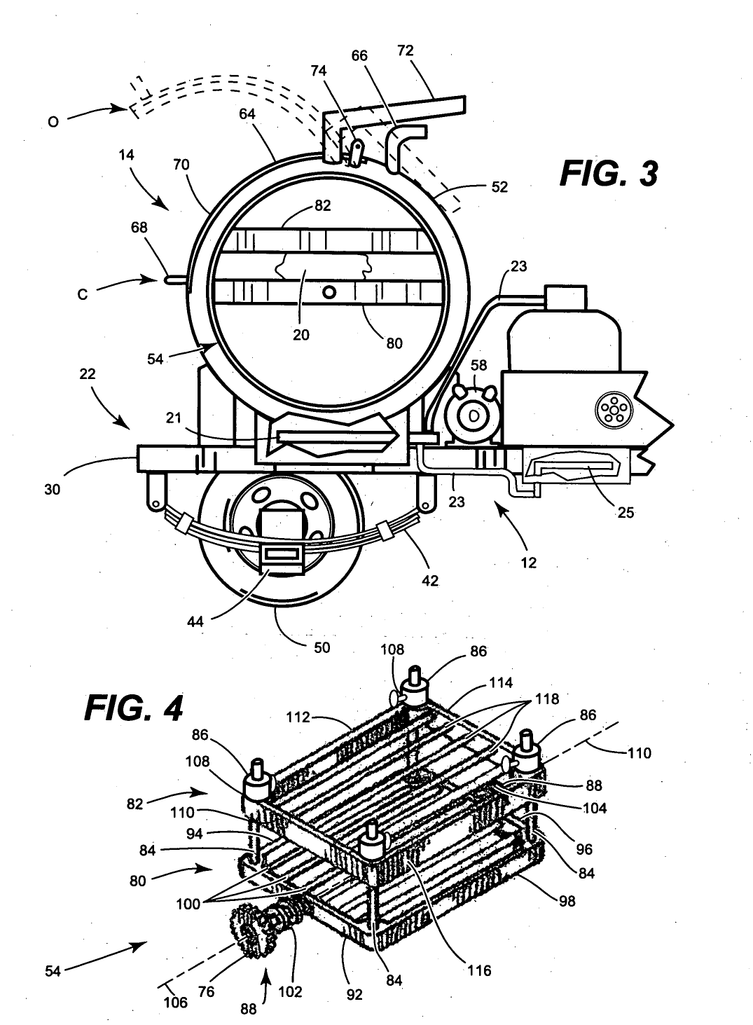

As shown in FIG. 3, the door 64 includes a handle 68, a cover 70, a counterweight 72, and a hinge 74. The counterweight 72 substantially balances the weight of the cover 70 about the pivot of the hinge 74 to reduce the effort needed to lift the cover 70. When fully open, the counterweight 72 bears against the cooking chamber 52 to limit the rotation of the cover 70 about a pivot axis of the hinge 74.The counterweight 72 shown in FIG. 1 is depicted as being generally rectangular in shape and fixedly attached (i.e., a fixed means of assisting to open the cover 70.) However it is contemplated herein that a counterweight of a different configuration and/or shape may be used. For example, axial coil springs, gas-charged cylinders, etc may be used as the means of assisting the user in opening the cover 70.

As shown in FIGS. 1-4, the drive system 56 includes a drive sprocket 74, a driven sprocket 76, and a chain 78. The drive sprocket 74 is attached to the motor 58. The driven sprocket 76 is attached to the rotisserie apparatus 54. The chain 78 translates the rotational motion from the motor 54 to the rotisserie apparatus 54, thus rotating the rotisserie apparatus 54 for evenly cooking the meat 20. While the drive system 56 shown is a chain-type, it is contemplated herein that any drive system 56 may be used to rotate the rotisserie apparatus 54 (e.g., belt drive, friction drive, shaft drive, gear drive).

As best shown in FIGS. 3 and 4, the rotisserie apparatus 54 includes a first grill unit 80, a second grill unit 82 spaced apart from the first grill unit 80 via extension rods 84 and secured by locks 86. The meat 20 is secured to the rotisserie apparatus 54 between the first grill unit 80 and the second grill unit 82. The second grill unit 82 is slideably engaged with the first grill unit 80, allowing the distance between the first grill unit 80 and the second grill unit 82 adjustable to accommodate different cuts of meat 20. The extension rods 84 are fixedly attached to the corners of the first grill unit 80 in a substantially perpendicular fashion from the substantially flat plane of the first grill unit 80, and are thus substantially parallel to each other. The locks 86 limit movement of the second grill unit 82 relative to the first grill unit 80. Though rectangular grill units 80 and 82 are shown, it is contemplated herein that the grill units 80 and 82 may be of a different shape or form. In addition, though four extension rods 84 are shown, it is contemplated herein that any number of elongated extension rods 84 may be used. It is further contemplated herein that any method of retaining the second grill unit 82 to the first grill unit 80 may be used (e.g. threaded fasteners, hooked fasteners, a hinge apparatus, adjustable straps, clamps).

The first grill unit 80 includes a drive axle 88, a support axle 90, a first side 92, a second side 94, a third side 96, a forth side 98, and grill bars 100. The grill bars 100 are fixedly attached to the first side 92 and third side 96. The grill bars 100 are substantially parallel to the second side 94 and the forth side 98 of the first grill unit 80, and in substantially the same plane as the first grill unit 80. It is contemplated herein that the grill bars 100 may be oriented in any direction or pattern. In addition, it is further contemplated herein that the grill bars 100 may be replaced entirely by a different surface (e.g., perforated sheet, wire mesh, solid surface).

The drive axle 88 includes the driven sprocket 76 and a drive axle-bearing journal 102. The drive axle 88 extends from the first side 92 of the first grill unit 80 in a substantially perpendicular direction to the first side 92, in a in a similar plane as first grill unit 80. The support axle 90 includes a support axle bearing journal 104, and extends from the third side 96 of the first grill unit 80 in a substantially perpendicular direction to the third side 96, in a in a similar plane as the first grill unit 80. A drive axis 106 extends along longitudinal axes of the drive axle 88 and the support axle 90.

The second grill unit 82 includes through holes 108, a first side 110, a second side 112, a third side 114, a forth side 116, and grill bars 118, which are fixedly attached to the first side 110 and third side 114 of the second grill unit 82. The grill bars 118 are substantially parallel to the second side 112 and the forth side 116 of the second grill unit 82, and in substantially the same plane as the second grill unit 82. It is contemplated herein that the grill bars 118 may be oriented in any direction or pattern. In addition, it is further contemplated herein that the grill bars 118 may be replaced entirely by a different surface (e.g., perforated sheet, wire mesh, solid surface).

Referring back to FIGS. 1-4, the drive axle 88 extends through the center of the second closed end 62 of the cooking chamber 52. The support axle 90 extends through the center of the first closed end 60 of the cooking chamber. The drive axle bearing journal 102 and the support axle-bearing journal 104 retain the rotisserie apparatus 54 in the axial direction of the drive axis 106.

In practice, the user grasps the handle 68 to open the door 64. The door rotates about the hinge 74 until the counterweight 72 bears against the cooking chamber 52. The user removes the locks 86, which release the second grill unit 82 from its limit on the extension rods 84 of the first grill unit 80. The user loads the meat 20 onto the grill bars 100 of the first grill unit 80, and installs the second grill unit 82 by aligning the through holes 108 with the ends of the extension rods 84. The locks 86 are installed over the extension rods 84 to secure the meat 20 between the grill bars 100 of the first grill unit 80 and the grill bars 118 of the second grill unit 82. The user closes the door 64, engages the heat source, and provides power to the motor 58 to begin rotation of the rotisserie apparatus 54 to evenly cook the meat.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A trailer-mounted grill, comprising:
a trailer including a frame structure and wheels rotatably attached to the trailer structure in a manner enabling the wheels to rollably support the frame structure on a surface;
a cooking chamber attached to the frame structure;
meat holding structure rotatably disposed within an interior space of the cooking chamber; and
a drive system coupled to the meat-holding structure for rotating the meat-holding structure with respect to the cooking chamber.

2. The trailer-mounted grill of claim 1 wherein:
the meat-holding structure includes spaced-apart grill units; and
a first one of said grill units is movable with respect to a second one of said grill units for enabling a food item to be secured therebetween.

3. The trailer-mounted grill of claim 2 wherein the second one of said grill units is adjustable with respect to the first one of said grill units.

4. The trailer-mounted grill of claim 3 wherein:
the first one of said grill units is rotatably mounted on the cooking chamber; and
the drive system is attached to the first one of said grill units for rotating the first one of said grill units with respect to the cooking chamber.

5. The trailer-mounted grill of claim 4 wherein:
the cooking chamber is drum-shaped; and
a rotational axis of the first one of said grill units extends along a longitudinal axis of the cooking chamber.

6. The trailer-mounted grill of claim 5 wherein:
the cooking chamber includes a main body and a door pivotably attached to the main body;
a pivot axis of the door extends generally parallel with the longitudinal axis of the cooking chamber;
the door covers an access opening in the main body; and
the door includes a counterweight extending therefrom away from the access opening such that the counterweight exerts a gravity-induced door opening force as the door is being moved from a closed position toward an open position.

7. The trailer-mounted grill of claim 1 wherein:
the cooking chamber is drum-shaped;
a rotational axis the meat-holding structure extends along a longitudinal axis of the cooking chamber;
the cooking chamber includes a main body and a door pivotably attached to the main body;
a pivot axis of the door extends generally parallel with the longitudinal axis of the cooking chamber;
the door covers an access opening in the main body; and
the door includes a counterweight extending therefrom away from the access opening such that the counterweight exerts a gravity-induced door opening force as the door is being moved from a closed position toward an open position.

8. A trailer-mounted grill, comprising:
a trailer including a frame structure and wheels rotatably attached to the trailer structure in a manner enabling the wheels to rollably support the frame structure on a surface;
a rotisserie grill assembly including a cooking chamber attached to the frame structure and a rotisserie apparatus rotatably attached to the cooking chamber, wherein the cooking chamber includes an interior space and wherein the rotisserie apparatus includes spaced-apart grill units within the interior space of the cooking chamber such that said grill units are rotatable within the interior space of the cooking chamber; and
a drive system engaged with the rotisserie apparatus for rotating the rotisserie apparatus with respect to the cooking chamber.

9. The trailer-mounted grill of claim 8 wherein:
a first one of said grill units is movable with respect to a second one of said grill units for enabling a food item to be secured therebetween; and
the second one of said grill units is adjustable with respect to the first one of said grill units.

10. The trailer-mounted grill of claim 9 wherein:
the first one of said grill units is rotatably mounted on the cooking chamber; and
the drive system is attached to the first one of said grill units for rotating the first one of said grill units with respect to the cooking chamber.

11. The trailer-mounted grill of claim 10 wherein:
the cooking chamber is drum-shaped; and
a rotational axis of the first one of said grill units extends along a longitudinal axis of the cooking chamber.

12. The trailer-mounted grill of claim 11 wherein:
the cooking chamber includes a main body and a door pivotably attached to the main body;
a pivot axis of the door extends generally parallel with the longitudinal axis of the cooking chamber;
the door covers an access opening in the main body; and
the door includes a counterweight extending therefrom away from the access opening such that the counterweight exerts a gravity-induced door opening force as the door is being moved from a closed position toward an open position.

13. The trailer-mounted grill of claim 8 wherein:
the cooking chamber is drum-shaped;
a rotational axis the meat-holding structure extends along a longitudinal axis of the cooking chamber;
the cooking chamber includes a main body and a door pivotably attached to the main body;
a pivot axis of the door extends generally parallel with the longitudinal axis of the cooking chamber;
the door covers an access opening in the main body; and
the door includes a counterweight extending therefrom away from the access opening such that the counterweight exerts a gravity-induced door opening force as the door is being moved from a closed position toward an open position.

14. A trailer-mounted grill, comprising:
a trailer including a frame structure and wheels rotatably attached to the trailer structure in a manner enabling the wheels to rollably support the frame structure on a surface;
a rotisserie grill assembly including a cooking chamber attached to the frame structure, a rotisserie apparatus rotatably attached to the cooking chamber and a gas burner mounted within the cooking chamber, wherein the cooking chamber includes an interior space and wherein the rotisserie apparatus includes spaced-apart grill units within the interior space of the cooking chamber such that said grill units are rotatable within the interior space of the cooking chamber;
a drive system engaged with the rotisserie apparatus for rotating the rotisserie apparatus with respect to the cooking chamber;
a deep fryer cooking structure attached to the frame structure adjacent the rotisserie grill assembly; and
a fuel tank attached to the frame structure in side-by-side relationship with respect to the deep fryer cooking structure, wherein the fuel tank is coupled to a burner of the cooking chamber and a burner of the deep fryer cooking structure for supplying fuel thereto.

15. The trailer-mounted grill of claim 14 wherein:
a first one of said grill units is movable with respect to a second one of said grill units for enabling a food item to be secured therebetween; and
the second one of said grill units is adjustable with respect to the first one of said grill units.

16. The trailer-mounted grill of claim 15 wherein:
the first one of said grill units is rotatably mounted on the cooking chamber; and
the drive system is attached to the first one of said grill units for rotating the first one of said grill units with respect to the cooking chamber.

17. The trailer-mounted grill of claim 16 wherein:
the cooking chamber is drum-shaped; and
a rotational axis of the first one of said grill units extends along a longitudinal axis of the cooking chamber.

18. The trailer-mounted grill of claim 17 wherein:
the cooking chamber includes a main body and a door pivotably attached to the main body;
a pivot axis of the door extends generally parallel with the longitudinal axis of the cooking chamber;
the door covers an access opening in the main body; and
the door includes a counterweight extending therefrom away from the access opening such that the counterweight exerts a gravity-induced door opening force as the door is being moved from a closed position toward an open position.

19. The trailer-mounted grill of claim 14 wherein:
the cooking chamber is drum-shaped;
a rotational axis the meat-holding structure extends along a longitudinal axis of the cooking chamber;
the cooking chamber includes a main body and a door pivotably attached to the main body;
a pivot axis of the door extends generally parallel with the longitudinal axis of the cooking chamber;
the door covers an access opening in the main body; and
the door includes a counterweight extending therefrom away from the access opening such that the counterweight exerts a gravity-induced door opening force as the door is being moved from a closed position toward an open position.
